(19) United States
(12) Patent Application Publication
(10) Pub. No.: US 2025/0376095 A1
(43) Pub. Date: Dec. 11, 2025

(54) RETAINER FOR A SEAT ASSEMBLY AND METHOD OF ASSEMBLY

(71) Applicant: LEAR CORPORATION, Southfield, MI (US)

(72) Inventors: David ABDELLA, Royal Oak, MI (US); Joshua HALLOCK, Warren, MI (US); Lisa SWIKOSKI, West Bloomfield, MI (US); Samuel BLAIR, Troy, MI (US)

(73) Assignee: LEAR CORPORATION, Southfield, MI (US)

(21) Appl. No.: 18/877,056

(22) PCT Filed: Jun. 16, 2023
(86) PCT No.: PCT/US2023/025543

§ 371 Date: Dec. 19, 2024

Related U.S. Application Data
(60) Provisional application No. 63/366,676, filed on Jun. 20, 2022.

(30) Foreign Application Priority Data
Jan. 19, 2023 (DK) PA202370028

(51) Int. Cl. B60N 2/58

(52) U.S. Cl. CPC B60N 2/5825; B60N 2/5883; B60N 2/5891

(57) ABSTRACT

A retainer is described that includes an elongated member attachable to a trim cover, and multiple anchors extending from the elongated member. Each of the anchors has a body with a first end attached to the elongated member and a second end opposite the first end, the second end terminating in a pointed tip. Each of the anchors has multiple barbs, each barb extending from the body in a direction away from the tip. For each of the plurality of anchors, a material of a mesh structure is gripped between the body and each of the barbs when the anchor is inserted into the mesh structure. A method of assembling a seat assembly including providing a retainer is also described.

### CROSS-REFERENCE TO RELATED APPLICATION

This application claims the benefit of U.S. Provisional Application Ser. No. 63/366,676 filed on Jun. 20, 2022, and Danish Patent Application No. PA202370028 filed on Jan. 19, 2023, the disclosures of both of which are hereby incorporated by reference herein in their entireties.

### TECHNICAL FIELD

The present disclosure relates to a retainer, a seat assembly having a retainer, and a method of assembly.

### BRIEF DESCRIPTION OF THE DRAWINGS

FIG. 1 a perspective view of a non-limiting, exemplary embodiment of a seat assembly;

FIGS. 2A-2C are perspective views of non-limiting, exemplary embodiments of a retainer according to the present disclosure;

FIG. 3 is side view of a non-limiting, exemplary embodiment of a retainer according to the present disclosure;

FIG. 4 is a side view of a non-limiting, exemplary embodiment of a retainer according to the present invention inserted into a cushion material; and

FIG. 5 is an exemplary flowchart illustrating a non-limiting, exemplary embodiment of a method according to the present disclosure.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, features, and elements have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” and/or “at least one” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, steps, operations, elements, and/or components, but do not preclude the presence or addition of one or more other features, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

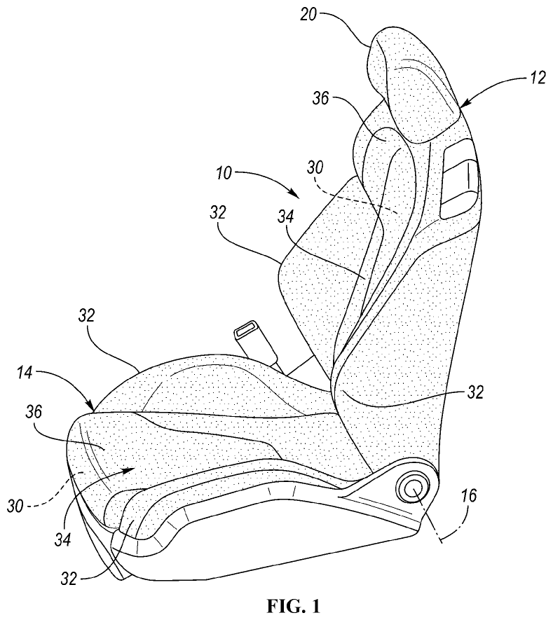

Referring to FIG. 1, a perspective view of a non-limiting, exemplary embodiment of a seat assembly 10 is shown. The seat assembly 10 may be configured for use in a vehicle, such as a motor vehicle like a car or truck. The seat assembly 10 may include a seat back 12 and a seat bottom 14. The seat back 12 may be configured to support the back of a seat occupant. The seat bottom 14 may be configured to support a seat occupant. In a vehicular application, the seat bottom 14 may be mounted to a support surface, such as a vehicle floor.

The seat back 12 may be pivotable about an axis 16 with respect to the seat bottom 14. For example, one or more recliner mechanisms, pivot pins, or the like may pivotally connect the seat back 12 to the seat bottom 14. Alternatively, the seat back 12 or a portion thereof may not be pivotally connected to the seat bottom 14. For instance, the seat back 12 may be pivotally mounted to a vehicle body structure, such as may be the case in some bench seat configurations.

The seat back 12 may include a head restraint 20 that may be configured to support the head of a seat occupant. The head restraint 20 may be disposed at the top of the seat back 12. The head restraint 20 may be unitary with the seat back 12 or may be a separate component that is adjustably positionable with respect to the top of the seat back 12.

The seat back 12 and the seat bottom 14 may each have at least one seat cushion 30. The seat back 12 and the seat bottom 14 may each also have side bolsters 32 and a center seating portion 34 of the cushion 30. A seat component 36 may be secured to the cushion 30 with one or more retainers as will be discussed in more detail below.

The seat component 36 may be disposed over or upon the cushion 30. The seat component 36 may have any suitable configuration and be of any suitable type. For instance, the seat component 36 may be a trim cover, trim cover material, or trim cover assembly that provides at least a portion of a visible exterior surface of the seat assembly 10. The trim cover 36 may include a plurality of trim panels that may be assembled in any suitable manner, such as by stitching. The trim panels may be made of any suitable material or materials, such as fabric, leather, vinyl, or combinations thereof. The seat component 36 may also or alternatively be a component that is concealed by or disposed under a trim cover and is disposed on the cushion 30, such as a temperature adjusting device like a heating pad or heating mat, an inflatable device for enhancing comfort of a seat occupant like a lumbar support or that provide massage functionality, an air-permeable material that facilitates airflow for a ventilated seat, or the like.

The cushion 30 may be at least partially concealed by the seat component 36 and may be directly or indirectly supported by a support structure of the seat assembly 10, such as a frame, panel, support wires, or the like. The cushion 30 includes a three-dimensional mesh structure formed of randomly looped and bonded filaments 60, only a small number of examples of which are shown in FIG. 4, pictorially represented by randomly drawn lines for simplicity. For example, the filaments 60 may be extruded filaments that are made of a polymeric material, such as a thermoplastic resin that is polyamide based, polyester based, polyimide based, polyolefin based, polypropylene based, polystyrene based, or combinations thereof. As one example, filaments 60 may be made of linear low-density polyethylene (LLDPE). The extruded filaments 60 may be randomly looped, curled, or entangled and may be bonded together where one filament 60 contacts another, thereby resulting in a lightweight, air permeable cushion having openings or voids between the filaments 60. A method of making an extruded filament mesh cushion is disclosed in U.S. patent application Ser. No. 17/555,875, filed on Dec. 20, 2021, entitled “System and Method of Making a Mesh Cushion,” a copy of which is attached hereto as Appendix A. As such, the cushion 30 may not be made of foam, such as urethane foam, and may partially or completely replace a conventional urethane foam cushion. Alternatively, the cushion may be a conventional foam cushion, such as a urethane foam cushion.

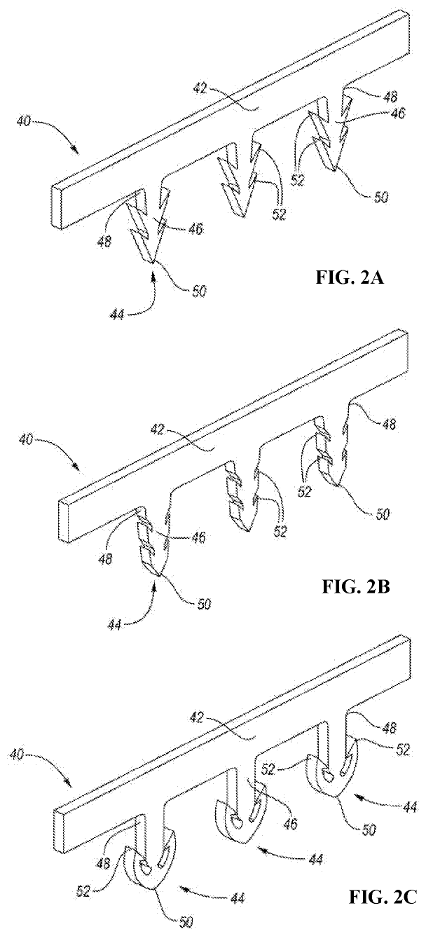

FIGS. 2A-2C are perspective views of non-limiting, exemplary embodiments of a retainer 40 according to the present disclosure. As seen therein, and with continuing reference to FIG. 1, the retainer 40 in each embodiment includes an elongated member 42 and a plurality of anchors 44. In that regard, the elongated member 42 comprises a planar strip and each of the plurality of anchors 44 is planar. Nevertheless, the elongated member 42 and anchors 44, individually or in combination, may take or be provided with any other suitable configuration.

In the embodiments shown in FIGS. 2A-2C, the elongated member 42 and the plurality of anchors 44 are formed as an integral piece, but may alternatively be individual components attached to each other In that regard, the retainer 40, including the elongated member 42 and the anchors 44, may be formed by injection molding, extrusion and die cutting, or by stamping or cutting (e.g., laser cutting) from a sheet. The elongated member 42 is also configured or provided for attachment to a trim cover 36. In that regard, the elongated member 42 may be sewn or stitched to the trim cover 36, although other known means or methods of attachment may alternatively be employed. The elongated member 42, with anchors 44, may also be cut to any length suitable or necessary for use in a particular application or environment wherein a component 36 is secured to a cushion 30 as described herein.

Each of the plurality of anchors 44 extending from the elongated member 42. Each of the plurality of anchors 44 has a body 46 with a first end 48 attached to the elongated member 42 and a second end 50 opposite the first end 48. The second end 50 terminates in a pointed tip. Each of the plurality of anchors 44 has a plurality of barbs 52, each barb 52 extending from the body 46 in a direction away from the tip at the second end 50 of the anchor 44. For each of the plurality of anchors 44, a material of a cushion 30 is gripped between the body 46 and each of the plurality of barbs 52 when the anchor 44 is inserted into the cushion 30 (see FIG. 4). In that regard, the pointed tip at the second end 50 of each anchor 44 may serve or function to pierce the material of the cushion 30.

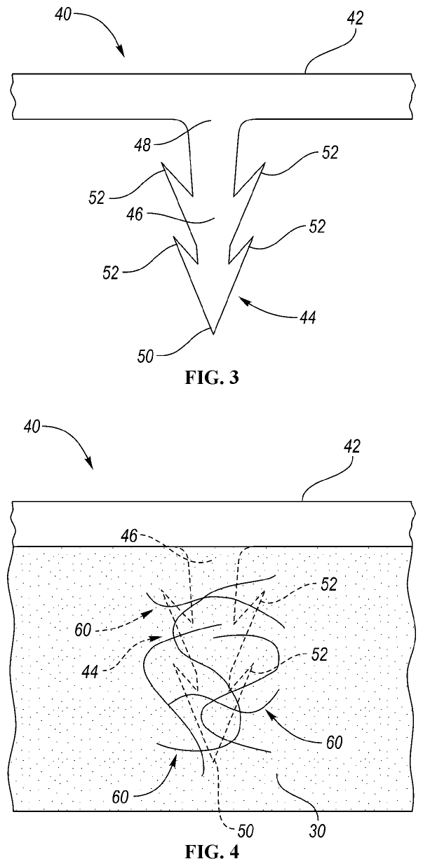

It is noted that the anchors 44, including the barbs 52, illustrated in FIGS. 2A-2C are exemplary only, and may generally take or be provided with any shape. The anchors 44 shown in FIG. 2A are provide with a shape that may be described as an inverted “Christmas tree,” while the anchors 44 shown in FIG. 2C are provided with a shape that may be described as a “ship anchor.” In that regard, FIG. 3 is side view of a non-limiting, exemplary embodiment of a retainer 40 according to the present disclosure. More specifically, a side view is shown of a single anchor 44 having an inverted “Christmas tree” shape from the embodiment of the retainer 40 of FIG. 2A.

In that regard, the size and shape of the individual anchors 44 extending from the elongated member 42 may be different. For example, the shape of the anchors 44 extending from an elongated member 42 may alternate between an inverted “Christmas tree” and a “ship anchor,” as respectively shown in FIGS. 2A and 2C. Moreover, while shown as equally spaced apart along the length of the elongated member 42, the distance between adjacent anchors 44 may be different and may vary. As well, the number of anchors per unit length of the elongated member 42 (i.e., density) may also vary.

It is also noted that the anchors 44 may generally take or be provided with any size. In that regard, an anchor 44 having a second end 50 terminated in a pointed tip with a sharp or acute angle and having a smaller cross-sectional area (for a cross-section taken across the body 46 of the anchor 44 in a direction parallel to the elongated member 42) requires the application of less force to insert the anchor 44 into a material of a cushion 30 than does an anchor 44 having a second end 50 terminating in a pointed tip with a greater angle and having a larger cross-sectional area. Thus, the anchors 44 of the embodiment shown in FIG. 2C generally require the application of a greater force for insertion into a cushion 30 than do the anchors 44 of the embodiments shown in FIGS. 2A and 2B.

It is still further noted that the number of barbs 52 for each of the anchors 44 illustrated in FIGS. 2A-2C is also exemplary only, and any number of barbs 52 may be provided. Moreover, the number of barbs 52 on each side of an anchor 44 may be different, the barbs 52 on each side of an anchor 44 need not be located directly across from each other (i.e., mirrored), the barbs 52 along a body 46 need not be equally spaced from each, and each barb 52 may take or be provided with a different shape. In that regard, the larger the size and/or the greater the number of the barbs 52 of an anchor 44, the more effective the anchor 44 is in grabbing a material of a cushion 30 and the more resistive the anchor 44 will be to removal from or backing out of the cushion 30. Thus, the anchors 44 of the embodiments shown in FIGS. 2A and 2C may be more resistive to removal from a cushion 30 than the anchors 44 of the embodiments shown in FIG. 2B.

It should be noted, however, that the optimal size and shape of an anchor 44, including barbs 52, may be dependent upon the nature of the material of the cushion 30. In that regard, for a cushion 30 including a three-dimensional mesh structure formed of randomly looped and bonded filaments 60 of an extruded polymeric material or materials as previously described, the manufacturing process may result in a cushion 30 having a material with a larger or smaller cell structure. As a result, the size and shape of one or more of the anchors 44 shown in FIGS. 2A-2C, or anchors 44 having a different size or shape than those shown, may be best suited to the material of a particular cushion 30.

FIG. 4 is another side view of a non-limiting, exemplary embodiment of a retainer 40 according to the present disclosure. As seen therein, a single anchor 44 having an inverted “Christmas tree” shape from the embodiment of the retainer 40 of FIG. 2A is shown, and the retainer 40 is partially disposed in a material of a cushion 30. More specifically, the anchor 44 of the retainer is shown in phantom inserted into the material of the cushion 30, with the elongated member 42 located at a surface of the cushion 30. As previously described, the elongated member 42 of the retainer 40 may be first sewn or stitched to a trim cover 36. Thereafter, the anchor 44 of the retainer 40 is inserted into the material of the cushion 30. In such a fashion, the trim cover 36 is thereby attached to the cushion 30.

The retainer 40 of the present disclosure may thus replace known mechanisms, devices, systems, means, or methods for attaching a trim cover 36 to a cushion 30, such as a conventional polyurethane foam cushion, including a clip attached to a trim cover 36 and configured to cooperate with a beaded Duon® attachment feature of a cushion 30, a hog ring and wire fastener, and/or any known attachment system including an attachment feature or fastener molded or formed into the cushion 30. In that regard, it is noted that the retainer 40 of the present disclosure need not be formed or molded into the material of a cushion 30. It is also noted that the retainer 40 of the present disclosure facilitates and/or enables attachment of a trim cover 36 to a cushion 30 that lacks a recess or recesses provided, formed, or created in the cushion for receiving the plurality of anchors 44, such as a cushion 30 having a three-dimensional mesh structure formed of randomly looped and bonded filaments 60 of an extruded polymeric material or materials as previously described. Nevertheless, the retainer 40 of the present disclosure is also suitable for attachment of a trim cover 36 to a cushion 30 that includes a recess or recesses, such as an elongated channel, hole, indentation, or trench provided, formed, or created therein for receiving the plurality of anchors 44, which recess or recesses may be provided in any suitable location, for example where a side bolster 32 meets a center seating portion 34 of the cushion 30 (see FIG. 1).

In that regard, as seen in FIG. 4, the cushion 30 includes a three-dimensional mesh structure formed of randomly looped and bonded filaments 60, only a small number of examples of which are shown, pictorially represented by randomly drawn lines for simplicity. As previously described, the second end 50 of the anchor 44 terminates in a pointed tip, and the plurality of barbs 52 extend from the body 46 in a direction away from the pointed tip of the anchor 44, which may serve or function to pierce the material of the cushion 30. As also previously described, when the anchor 44 is inserted into the cushion 30, the material of the cushion 30 (i.e., the looped and bonded filaments 60) is gripped between the body 46 and each of the plurality of barbs 52. The retainer 40 of the present disclosure thus provides a trim retainer designed to bit into a material of a cushion 30, such as strands or filaments of foamless mesh cushions or pads. The retainer 40 of the present disclosure also provides barbs or barbed attachments to enable or facilitate adhesion of a trim cover 36 to a cushion 30, such as strands or filaments of foamless mesh cushions or pads.

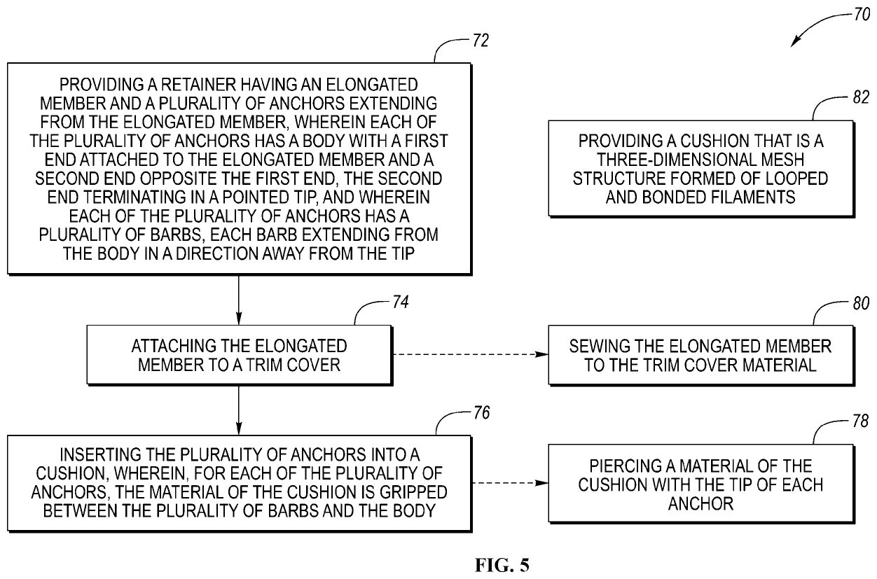

Referring next to FIG. 5, an exemplary flowchart is shown illustrating a non-limiting, exemplary embodiment of a method 70 according to the present disclosure. As seen therein, and with continuing reference to FIGS. 1-4, a method 70 of assembling a seat assembly comprises providing 72 a retainer 40 having an elongated member 42 and a plurality of anchors 44 extending from the elongated member 42, wherein each of the plurality of anchors 44 has a body 46 with a first end 48 attached to the elongated member 42 and a second end 50 opposite the first end 48, the second end 50 terminating in a pointed tip, and wherein each of the plurality of anchors 44 has a plurality of barbs 52, each barb 52 extending from the body 46 in a direction away from the tip. The method further comprises attaching 74 the elongated member 42 to a trim cover 36, and inserting 76 the plurality of anchors 44 into a cushion 30, wherein, for each of the plurality of anchors 44, the material of the cushion 44 is gripped between the plurality of barbs 52 and the body 46.

According to the method 70 of assembly of the present disclosure, inserting 76 the plurality of anchors 44 into a cushion 30 may comprise piercing 78 a material of the cushion 30 with the tip of each anchor 44. As previously described, the elongated member 42 may comprise a planar strip and attaching 74 the elongated member 42 to the trim cover 36 may comprise stitching or sewing 80 the elongated member 42 to the trim cover 36.

Once again, according to the method 70 of the present disclosure the plurality of anchors 44 may be spaced apart along the elongated member 42 with an equal distance between adjacent anchors 44, although alternative spacing of the anchors 44 may be provided as previously described. As also previously described, the elongated member 42 and the plurality of anchors 44 may be or may be formed as an integral piece.

The method 70 of assembly of the present disclosure my further comprise providing 82 a cushion 30 that is a three-dimensional mesh structure formed of looped and bonded filaments, as previously described. As also previously described, such filaments may be extruded and formed into the three-dimensional mesh structure. Moreover, the assembly method 70 of the present disclosure also facilitates and/or enables attachment of a trim cover 36 to a cushion 30 that lacks a recess or recesses formed in the cushion for receiving the plurality of anchors 44, such as a cushion 30 having a three-dimensional mesh structure formed of randomly looped and bonded filaments 60 of an extruded polymeric material or materials as previously described. Nevertheless, the retainer 40 of the present disclosure is also suitable for attachment of a trim cover 36 to a cushion 30 that includes a recess or recesses provided, formed, or created therein.
Item 1: According to an embodiment, the present disclosure provides a retainer comprising an elongated member attached to a trim cover, and a plurality of anchors extending from the elongated member, wherein each of the plurality of anchors has a body with a first end attached to the elongated member and a second end opposite the first end, the second end terminating in a pointed tip, and wherein each of the plurality of anchors has a plurality of barbs, each barb extending from the body in a direction away from the tip, wherein, for each of the plurality of anchors, a material of a cushion is gripped between the body and each of the plurality of barbs when the anchor is inserted into the cushion.
Item 2: In another embodiment, the present disclosure provides the retainer according to Item 1 wherein the elongated member comprises a planar strip.
Item 3: In another embodiment, the present disclosure provides the retainer according to any of Items 1-2 wherein each of the plurality of anchors is planar.
Item 4: In another embodiment, the present disclosure provides the retainer according to any of Items 1-3 wherein the elongated member is sewn to the trim cover.
Item 5: In another embodiment, the present disclosure provides the retainer according to any of Items 1-4 wherein the plurality of anchors is spaced apart along the elongated member with an equal distance between adjacent anchors.
Item 6: In another embodiment, the present disclosure provides the retainer according to any of Items 1-5 wherein the elongated member and the plurality of anchors are formed as an integral piece.
Item 7: In another embodiment, the present disclosure provides the retainer according to any of Items 1-6 wherein the retainer is formed by injection molding, or by stamping or cutting from a sheet.
Item 8: In another embodiment, the present disclosure provides the retainer according to any of Items 1-7 wherein the pointed tip pierces the cushion material.
Item 9: In another embodiment, the present disclosure provides the retainer according to any of Items 1-8 wherein the material of the cushion comprises a mesh formed from looped and bonded filaments.
Item 10: In another embodiment, the present disclosure provides the retainer according to Item 9 wherein the filaments are extruded and formed into a three-dimensional structure.
Item 11: In another embodiment, the present disclosure provides the retainer according to any of Items 1-10 wherein the material of the cushion lacks a formed recess for receiving the plurality of anchors.
Item 12: In another embodiment, the present disclosure provides a seat assembly comprising a cushion, a trim cover, and a retainer according to any of Items 1-11, wherein the retainer attaches the trim cover to the cushion.
Item 13: According to an embodiment, the present disclosure provides a method of assembling a seat assembly, the method comprising providing a retainer having an elongated member and a plurality of anchors extending from the elongated member, wherein each of the plurality of anchors has a body with a first end attached to the elongated member and a second end opposite the first end, the second end terminating in a pointed tip, and wherein each of the plurality of anchors has a plurality of barbs, each barb extending from the body in a direction away from the tip, attaching the elongated member to a trim cover, and inserting the plurality of anchors into a cushion, wherein, for each of the plurality of anchors, the material of the cushion is gripped between the plurality of barbs and the body.
Item 14: In another embodiment, the present disclosure provides the method of Item 13 wherein inserting the plurality of anchors into a cushion comprises piercing a material of the cushion with the tip of each anchor.
Item 15: In another embodiment, the present disclosure provides the method according to any of Items 13-14 wherein the elongated member comprises a planar strip and attaching the elongated member to the trim cover comprises sewing the elongated member to the trim cover.
Item 16: In another embodiment, the present disclosure provides the method according to any of Items 13-15 wherein the plurality of anchors is spaced apart along the elongated member with an equal distance between adjacent anchors.
Item 17: In another embodiment, the present disclosure provides the method according to any of Items 13-16 wherein the elongated member and the plurality of anchors are an integral piece.
Item 18: In another embodiment, the present disclosure provides the method according to any of Items 13-17 further comprising providing a cushion that is a three-dimensional mesh structure formed of looped and bonded filaments.
Item 19: In another embodiment, the present disclosure provides the method according to Item 18 wherein the filaments are extruded and formed into the three-dimensional mesh structure.
Item 20: In another embodiment, the present disclosure provides the method according to any of Items 13-19 wherein the material of the cushion lacks a formed recess for receiving the plurality of anchors.

While exemplary embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, unless the context clearly indicates otherwise, the various features, elements, components, methods, procedures, steps, and/or functions of various implementing embodiments may be combined or utilized in any combination or combinations and/or may be performed in any order other than those specifically described herein to form further embodiments according to the present disclosure.

1. A retainer comprising:
an elongated member attachable to a cover; and
a plurality of anchors extending from the elongated member, wherein each of the plurality of anchors has a body with a first end attached to the elongated member and a second end opposite the first end, the second end terminating in a pointed tip, and wherein each of the plurality of anchors has a plurality of barbs, each barb extending from the body in a direction away from the tip;
wherein, for each of the plurality of anchors, a material of a mesh structure is gripped between the body and each of the plurality of barbs when the anchor is inserted into the mesh structure.

2. The retainer according to claim 1 wherein the elongated member comprises a planar strip.

3. The retainer according to claim 1 wherein each of the plurality of anchors is planar.

4. The retainer according to claim 1 wherein the elongated member is sewn to the trim cover.

5. The retainer according to claim 1 wherein the plurality of anchors is spaced apart along the elongated member with an equal distance between adjacent anchors.

6. The retainer according to claim 1 wherein the elongated member and the plurality of anchors are formed as an integral piece.

7. The retainer according to claim 1 wherein the retainer is formed by injection molding, or by stamping or cutting from a sheet.

8. The retainer according to claim 1 wherein the pointed tip pierces the cushion material mesh structure.

9. The retainer according to claim 1 wherein the material of the cushion mesh structure comprises a mesh formed from looped and bonded filaments.

10. The retainer according to claim 9 wherein the filaments are extruded and formed into a three-dimensional structure.

11. The retainer according to claim 1 wherein the mesh structure lacks a formed recess for receiving the plurality of anchors.

12. A seat assembly comprising:
a mesh structure;
a cover; and
a retainer according to claim 1, wherein the retainer attaches the trim cover to the cushion.

13. A method comprising:
providing a retainer having an elongated member and a plurality of anchors extending from the elongated member, wherein each of the plurality of anchors has a body with a first end attached to the elongated member and a second end opposite the first end, the second end terminating in a pointed tip, and wherein each of the plurality of anchors has a plurality of barbs, each barb extending from the body in a direction away from the tip;
attaching the elongated member to a cover; and
inserting the plurality of anchors into a mesh structure, wherein, for each of the plurality of anchors, the mesh structure is gripped between the plurality of barbs and the body.

14. The method of claim 13 wherein inserting the plurality of anchors into a mesh structure comprises piercing a material of the mesh structure with the tip of each anchor.

15. The method according to claim 13 wherein the elongated member comprises a planar strip and attaching the elongated member to the trim cover comprises sewing the elongated member to the trim cover.

16. The method according to claim 13 wherein the plurality of anchors is spaced apart along the elongated member with an equal distance between adjacent anchors.

17. The method according to claim 13 wherein the elongated member and the plurality of anchors are an integral piece.

18. The method according to claim 13 further comprising providing a mesh structure comprising a three-dimensional mesh structure formed of looped and bonded filaments.

19. The method according to claim 18 wherein the filaments are extruded and formed into the three-dimensional mesh structure.

20. The method according to claim 13 wherein the mesh structure lacks a formed recess for receiving the plurality of anchors.
